(19) United States
(12) Patent Application Publication
(10) Pub. No.: US 2011/0180363 A1
(43) Pub. Date: Jul. 28, 2011

(54) ELECTRO-MECHANICAL CLUTCH ACTUATOR ASSEMBLY

(75) Inventor: Mikael Westerberg, Vaenersborg (SE)

(73) Assignee: GM GLOBAL TECHNOLOGY OPERATIONS LLC, Detroit, MI (US)

(21) Appl. No.: 13/011,505

(22) Filed: Jan. 21, 2011

(30) Foreign Application Priority Data
Jan. 22, 2010 (GB) 1001027.0

(51) Int. Cl. F16D 28/00

(52) U.S. Cl. 192/84.9

(57) ABSTRACT

A clutch actuator assembly is disclosed that includes, but is not limited to an electric motor with a gear arrangement. The gear arrangement includes, but is not limited to a worm gear with a threaded worm rod and a worm wheel with an actuator section. The worm wheel is actuated by the worm rod and the worm rod is actuated by the electric motor. The worm wheel further includes, but is not limited to an advance gear section with an advance thread. A stationary thread of the clutch actuator assembly engages with the advance thread. The gear arrangement includes, but is not limited to a self-locking feature that at least inhibits, and preferably prevents the actuator section from moving when the electric motor is not actuated.

### CROSS-REFERENCE TO RELATED APPLICATION

This application claims priority to British Patent Application No. 1001027.0, filed Jan. 22, 2010, which is incorporated herein by reference in its entirety.

### TECHNICAL FIELD

The technical field relates to a clutch actuator assembly, and more particularly to an electro-mechanical clutch actuator assembly.

### BACKGROUND

The operation of a launch clutch via an electromechanical clutch actuator provides an alternative to hydraulic or pneumatic clutch actuation. Electromechanical clutch actuators are used for example in automatic manual transmission and double clutch transmissions. Several types of electromechanical clutch actuators are known. One type of clutch actuator comprises a movable slide. The motion of the slide is driven by a worm gear that is attached to an electric motor. The slide acts as a pivot point of a lever arm such that the force of a spring onto the lever arm is translated into an output force that varies with the position of the slide. According to a further type, one end of a Bowden wire is connected to a spindle drive of an electric motor. The other end of the Bowden wire is connected to a disk with a ramp that translates the rotational motion of the disk into a throw-out motion of a clutch release bearing.

In view of the foregoing, at least one object is to provide an improved clutch actuator assembly for actuating a single clutch and at least another object is to provide an arrangement of two electromechanical clutch actuator assemblies for actuating a double clutch. The clutch actuator assembly will also be referred to as electromechanical clutch actuator. In addition, other objects, desirable features and characteristics will become apparent from the subsequent summary and detailed description, and the appended claims, taken in conjunction with the accompanying drawings and this background.

### SUMMARY

A clutch actuator assembly is disclosed that comprises an electric motor with a gear arrangement. The gear arrangement comprises a worm gear with a threaded worm rod and a worm wheel. An actuator section, for example a clutch release bearing, is attached to the worm wheel for actuating a clutch. The worm wheel is actuated by the worm rod and the worm rod is actuated by the electric motor. The worm wheel further comprises an advance gear section with an advance thread. A stationary thread of the clutch actuator assembly engages with the advance thread. The gear arrangement comprises a self-locking feature that prevents the actuator section from moving when the electric motor is not actuated. More specifically, the self-locking feature is provided by the form of one or more of the threads such as the inclination or the form of the flanks of the threads.

In embodiments, the worm wheel is provided by a first cylindrical and a second cylindrical part. A second thread of the worm wheel that meshes with a thread of the worm rod is provided on the circumference of the first cylindrical part. The advance gear section of the worm wheel is provided by the second cylindrical part. The stationary thread is provided by a thread on an inner surface of a cup shaped part. In the embodiments, the first and the second cylindrical parts are parts of a second portion of the clutch actuator assembly that is rotatable around an axis of rotation. The axis of rotation coincides with a symmetry axis of an output shaft. The worm rod and the cup shaped part are parts of a first and a third portion of the clutch actuator assembly, respectively.

In an embodiment of the application, the stationary thread is provided on a surface of a cup shaped part that is attached to a clutch casing. In a further embodiment, the stationary thread is provided by a thread of a clutch casing. The stationary thread is formed as internal thread or also as external thread.

In an embodiment, a thread of the worm wheel is provided by a female thread on a circumference of a first cylindrical part and an advance thread of the worm wheel is provided by a male thread on a circumference of a second cylindrical part. Thereby, an engaging thread on a rod can be realized as male thread and an engaging stationary internal thread can be realized as female thread, which is easy to machine.

In an embodiment, the motor and the threaded worm rod are movable along an axis of movement. A guiding means for moving the motor and the worm rod along the axis of movement is provided which is connected to the motor. The guiding means engages with an engaging section that is connected to the worm wheel. The engaging section is provided at a second portion of the clutch actuator assembly.

In an embodiment, the stationary thread is provided on a surface of a cup shaped part and the cup shaped part is attached to a clutch casing.

Furthermore, an arrangement is disclosed for two clutch actuator assemblies for actuating a double clutch. The arrangement comprises a first clutch actuator assembly according to one of the application for actuating a first clutch of the double clutch and a second clutch actuator assembly according to the application for actuating a second clutch of the double clutch. The clutch actuator assemblies are nested within each other such that the advance thread of the first electromechanical clutch actuator partially encloses the advance thread of the second electromechanical clutch actuator.

### BRIEF DESCRIPTION OF THE DRAWINGS

The present invention will hereinafter be described in conjunction with the following drawing figures, wherein like numerals denote like elements, and:

FIG. 1 illustrates a side view of a first embodiment of an electromechanical clutch actuator;

FIG. 2 illustrates a cross section of a clutch in an open position and the electromechanical clutch actuator of FIG. 1;

FIG. 3 illustrates a cross section of a clutch in a closed position and the electromechanical clutch actuator of FIG. 1;

FIG. 4 illustrates a side view of a second embodiment of an electromechanical clutch actuator with a guiding means;

FIG. 5 illustrates a cross section of the first cylindrical part and of the guiding means of the electromechanical clutch actuator of FIG. 4; and

FIG. 6 illustrates a cross section of a double clutch with two electromechanical clutch actuators according to a third embodiment.

### DETAILED DESCRIPTION

The following detailed description is merely exemplary in nature and is not intended to limit application and uses. Furthermore, there is no intention to be bound by any theory presented in the preceding background or summary or the following detailed description.

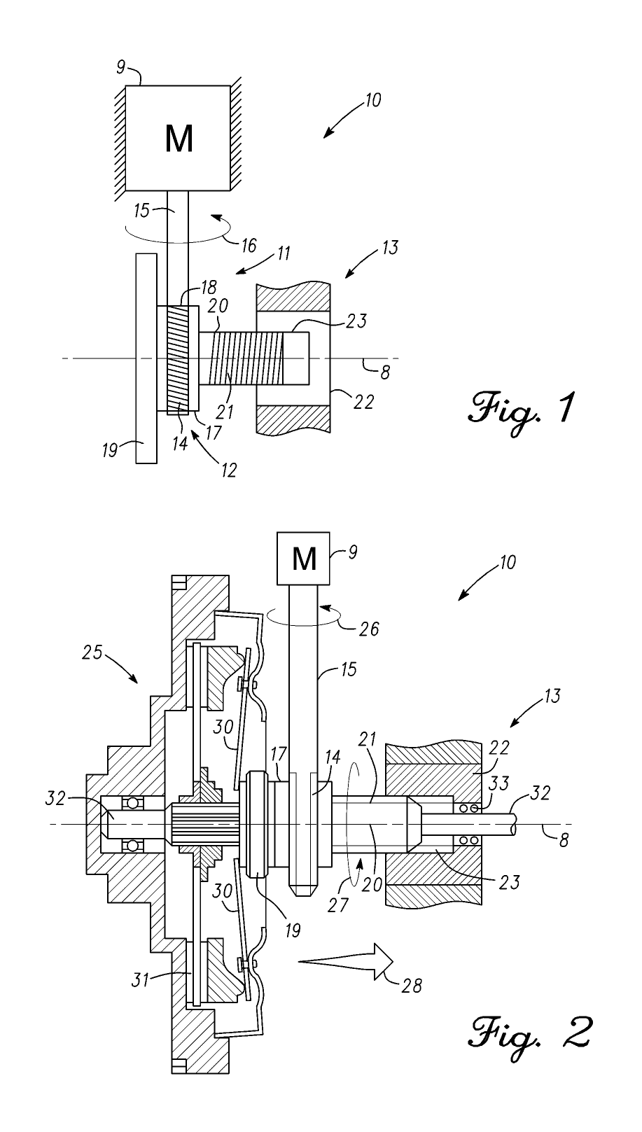

FIG. 1 shows a schematic side view of an electromechanical clutch actuator 10. The electromechanical clutch actuator 10 comprises a first portion 11, a second portion 12 and a stationary third portion 13. The first portion 11 is oriented perpendicular to an axis 8 of an output shaft, which is not shown in FIG. 1, while the second portion 12 and the stationary third portion 13 are arranged concentrically to the axis 8.

The first portion 11 comprises an electric motor 9 and a rod 15 or shaft that is attached to an axis of the electric motor 9. The rod 15 comprises a thread 14 at the end of the rod 15. The rotation of the rod 15 around the axis of the electric motor 9 is indicated by an arrow 16.

The second portion 12 comprises a first threaded cylindrical part 17. A thread 18 on the circumference of the first threaded cylindrical part 17 meshes with the thread 14 on the rod 15. A clutch release bearing 19 is in contact with one side of the first threaded cylindrical part 17. A second threaded cylindrical part 20 with a thread 21 is attached to the opposite side of the first threaded cylindrical part 17.

The stationary third portion 13 comprises a cup shaped part 22 that is attached to a clutch housing. The clutch housing is not shown in FIG. 1. An internal thread 23 is provided at the inside of the cup shaped part 22. The internal thread 23 meshes with the thread 21 of the second threaded cylindrical part 20. A circular opening for taking up the output shaft is provided at the bottom of the cup shaped part 22. The opening can be seen in the cross sections of FIG. 2 and FIG. 3.

The threads of the rod 15, the first threaded cylindrical part 17, the second threaded cylindrical part 20 and the cup shaped part 22 are threads of low inclination. Low inclination means that the inclination angle of the thread is substantially smaller than approximately 45° relative to a surface that is perpendicular to a rotation axis. The rotation axis is defined by the symmetry axis of the respective thread. The inclination angle of a thread is also known as the lead angle. In particular, the inclination of the threads of the rod 15, the first cylindrical part 17, the second threaded cylindrical part 20, and the cup shaped part are such that the electromechanical clutch actuator 10 provides a self-locking feature. Therefore, the second portion 12 of the electromechanical clutch actuator 10 is prevented from moving if the electric motor 9 is not actuated.

In the embodiment of FIG. 1, the dimensions of the parts are related as follows. The diameter of the clutch release bearing 19 is greater than the diameter of the first threaded cylindrical part 17 that is in turn greater than the diameter of the second threaded cylindrical part 20. The thickness, measured along the axis 8, of the clutch release bearing 19 is smaller than the thickness of the first threaded cylindrical part 17 that is in turn smaller than the thickness of the second threaded cylindrical part 20.

The width of the thread 18 of the first threaded cylindrical part 17 along the 8 is dimensioned such that the thread 18 of the first cylindrical part 17 and the thread 14 of the rod 15 mesh over a range of movement of the first cylindrical part 17, which is sufficient to open and to close a clutch via the clutch release bearing 19.

FIG. 2 and FIG. 3 show cross sections of a naturally closed clutch 25 with an electromechanical clutch actuator 10 according to FIG. 1. The clutch release bearing 19 and a spline shaft are shown in side view. FIG. 2 shows the clutch 25 in an open position and FIG. 3 shows the clutch 25 in a closed position. In the following, right-handed threads are assumed. The sense of rotation of the rod 15 is described as seen from the electric motor 9 and the sense of rotation of the first threaded cylindrical part 17 is described as seen from the clutch 25.

As indicated in FIG. 2 and FIG. 3, the cylindrical parts 17 and 20 are hollow and the bottom of the cup shaped part 22 has a circular opening. An output shaft 32 is arranged concentrically within the cylindrical parts 17 and 20 and within the circular opening of the cup shaped part 22. The output shaft 32 is supported by a bearing 33 that is located between the output shaft 32 and the circular opening of the cup shaped part 22 and by a further bearing that is located between the output shaft 32 and a clutch casing of the clutch 25. The clutch casing is connected to a flywheel and the flywheel is connected to an output shaft of an engine in a known way. The flywheel and the engine are not shown.

To close the clutch 25 that is shown in an open position in FIG. 2, the electric motor 9 is supplied with a current such that the electric motor 9 turns the rod 15 in an anti-clockwise direction, as indicated by arrow 26. The anticlockwise rotation of the thread 14 of the rod 15 turns the first threaded cylindrical part 17 via the engagement of the thread 14 with the thread 18 of the first threaded cylindrical part 17. The clockwise rotation of the first threaded cylindrical part 17 is indicated by an arrow 27. The first threaded cylindrical part 17 transmits its clockwise rotation to the second threaded cylindrical part 20. The second threaded cylindrical part 20 moves into the cup shaped part 22 via the engagement of the internal thread 23 of the second threaded cylindrical part 20 with the internal thread 23 at the inside of the cup shaped part 22. The second portion 11 of the electromechanical clutch actuator 10 moves inwards towards the cup shaped part 22 and away from the clutch 25. The inward movement of the second portion 11 is indicated by an arrow 28.

A spring 30 of the clutch 25 presses the clutch release bearing 19 against the first threaded cylindrical part 17. The clutch release bearing 19 moves away from a clutch disk 31. The outward movement of the spring 30 is translated into a pressure against a friction disk via a pivot mounting of the spring 30. The friction disk is pressed against the clutch disk and the rotation of the friction disk is transmitted to the clutch disk that is connected to the output shaft 32.

To open the clutch 25, which is shown in a closed position in FIG. 3, the electric motor 9 is supplied with a current such that the electric motor 9 turns the rod 15 in a clock-wise direction, as indicated by arrow 35. The rod 15 turns the first threaded cylindrical part 17 in an anticlockwise direction via the engagement of the thread 14, as indicated by an arrow 27. The first threaded cylindrical part 17 transmits its rotation to the second threaded cylindrical part 20. The second threaded cylindrical part 20 moves out of the cup shaped part 22 and towards the clutch 25. The outward movement of the second threaded cylindrical part 20 is indicated by an arrow 37.

The outward movement of the second threaded cylindrical part 20 is transmitted to the first threaded cylindrical part 17 and to the clutch release bearing 19. The clutch release bearing presses the spring 30 inwards towards the clutch 25. The inward movement of the spring 30 is translated into an outward movement of the friction disk via the pivot mounting of the spring 30. The friction disk is released from the clutch disk.

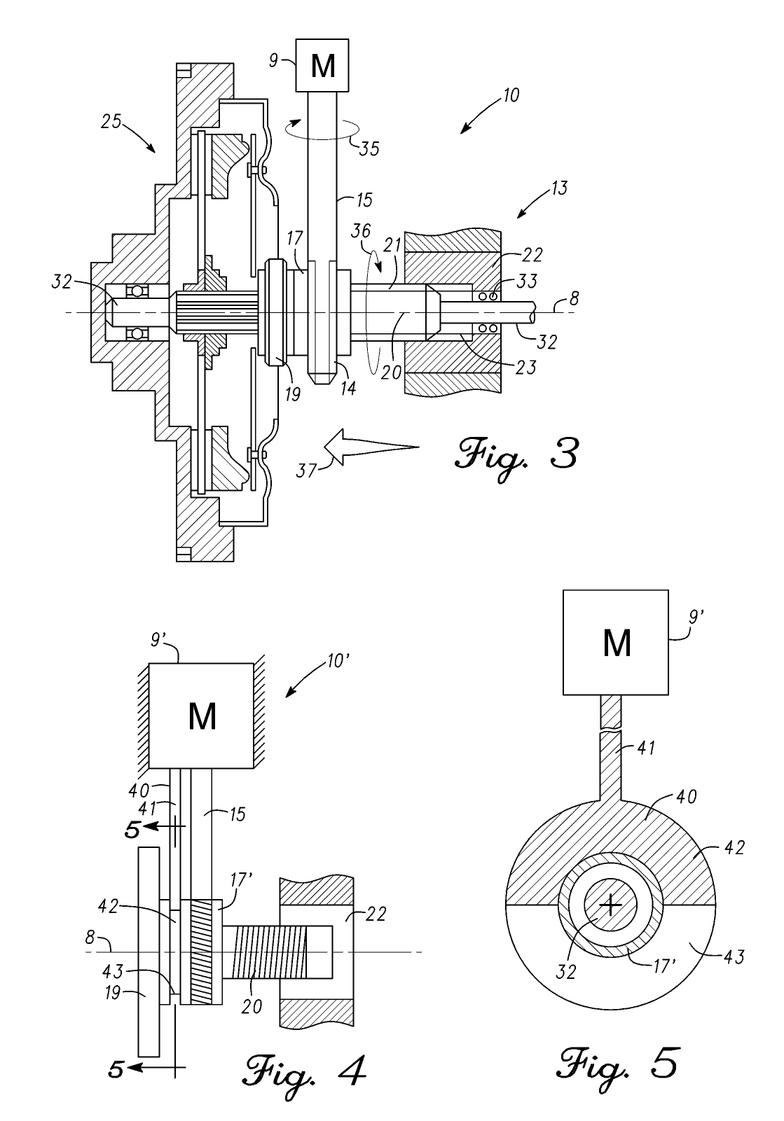

FIG. 4 and FIG. 5 show a second embodiment of an electromechanical clutch actuator in which the electric motor 9 is supported in such a way that it is movable parallel to the axis 8, but such that the movement of the electric motor 9 is constrained to a plane which contains the axis 8. A guiding means connects the first portion 11 to the second portion 11 such that the movement of the first portion 11 follows the movement of the second portion 11.

FIG. 4 shows a side view of a second embodiment electromechanical clutch actuator 10′. Identical parts have the same reference number, similar parts have a primed reference number. Different from the previous embodiment, the thread 18 on the circumference of the first cylindrical part 17 has essentially the same width as the thread 14 at the end of the rod 15.

In addition to the features shown in FIG. 1, the electromechanical clutch actuator 10′ of FIG. 4 comprises a guiding means 40 that is attached to the electric motor 9′. The guiding means comprises a finger portion 41 and a fork portion 42. The finger portion is fixed to an attachment at the casing of the electric motor 9′ at one end. The fork portion 42, which is provided at the other end of the finger portion, is shaped in the form of a half circle. The fork portion 42 engages with a circular groove 43 at the outside of the first cylindrical part 17′.

If the first cylindrical part 17′ moves towards or away from the cup shaped part 22, the side walls of the guiding groove 43 move the guiding means 40 and the attached electric motor 9′ in the direction of movement of the first cylindrical part 17′.

FIG. 5 shows a cross section of the guiding means 40, the first cylindrical part 17′ and the output shaft 32. In the lower part of FIG. 5, a sidewall of the circular groove 43 is shown.

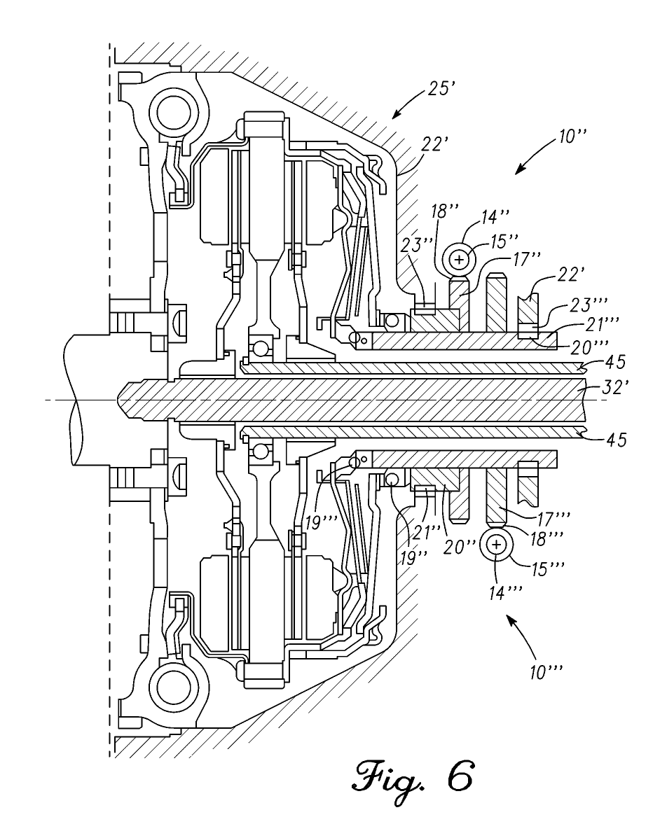

FIG. 6 shows a cross section of a double clutch 25′ that comprises two naturally open clutches. The clutches of the double clutch 25′ are actuated from a first electromechanical clutch actuator 10″ and a second electromechanical clutch actuator 10′″ according to a third embodiment. In FIG. 6, the electric motors of the actuators 10″ and 10′″ are outside the cross section and are therefore not shown. Only the features of the electromechanical clutch actuators 10″, 10′″ that are different from the electromechanical clutch actuator 10 of FIG. 1 will be explained below.

An inner output shaft 32′ is arranged concentrically within a hollow output shaft 45. A first and a second clutch disk are mounted on splined sections of the hollow output shaft 45 and the output shaft 32′, respectively. A first and a second friction disk are actuated by the electromechanical clutch actuators 10″ and 10′″, respectively.

A second threaded cylindrical part 20′″ of the electromechanical clutch actuator 10′″ is arranged concentrically within a second threaded cylindrical part 20″ of the electromechanical clutch actuator 10″.

A first threaded cylindrical part 17″ of the electromechanical clutch actuator 10″, which is formed as a gearwheel, is mounted on the second threaded cylindrical part 20″ of the electromechanical clutch actuator 10″. A thread 18″ of the first threaded cylindrical part 17″, which is formed as teeth of the first threaded cylindrical part 17″, engages with a thread 14″ of a rod 15″, which is connected to an electrical motor. An internal thread 23″ on the inside of a first threaded circular opening of a clutch casing 22′ engages with a thread 21″ on the outside of the second threaded cylindrical part 20″.

Likewise, a first threaded cylindrical part 17′″ of the electromechanical clutch actuator 10′″, which is formed as a gearwheel, is mounted on the second threaded cylindrical part 20′″ of the electromechanical clutch actuator 10′″. A thread 18′″ of the first threaded cylindrical part 17′″, which is formed as teeth of the first cylindrical part 17′″, engages with a thread 14′″ of a rod 15′″, which is connected to an electrical motor. An internal thread 23′″ on the inside of a second threaded circular opening of a clutch casing 22′ engages with a thread 21′″ on the outside of the second threaded cylindrical part 20′″.

A roller bearing, which is not shown in FIG. 6, is provided between the second cylindrical part 20″ of the electromechanical clutch actuator 10″ and the second cylindrical part 20′″ of the electromechanical clutch actuator 10′″, such that the second cylindrical part 20′″ is free to rotate within the second cylindrical part 20″ and the second cylindrical part 20′″ is supported within the second cylindrical part 20″. A dual mass flywheel of the double clutch 25′ is connected to an output shaft of an engine, as shown on the left hand side of FIG. 6.

Due to the self-locking feature, an electromechanical clutch according to the application requires no additional energy to keep a naturally open clutch in a closed position. This is especially advantageous in double clutch transmissions in which at least one of the clutches is realized as naturally open clutch. Due to the energy savings, the emissions of a combustion engine are reduced as well.

The electromechanical clutch actuator according to the application can be used with both naturally open and naturally closed clutches, however. Furthermore, it can be used with advantage in double clutch transmissions (DCT) and in automated manual transmissions (AMT). The electromechanical clutch actuator can be realized with very few parts only. No hydraulic lines and no sealing against leakage are required, no refilling of hydraulic fluid is necessary.

With a low inclination of the threads, a relatively low output torque of a fast turning electric motor can be transformed in a relatively high actuation force. Moreover, a low inclination of the threads provides a self-locking feature that prevents the actuator from sliding out of position when the electric motor is turned off, even when no additional means such as brake mechanisms are provided. The thread may have a special form to enhance the self-locking feature, for example a certain inclination of the thread flanks. The threads may be formed, for example, in a saw-shape or a trapezoidal shape such as in Buttress, V-shaped and Acme threads. The Acme and Buttress threads have the advantage of supporting high loads whilst the V-thread can provide a larger friction surface for the self-locking feature. The threads may furthermore have multiple start threads to increase linear motion for faster clutch actuation.

The threaded parts of the electromechanical clutch actuator may be produced out of standard parts with standard machine tools. Therefore, a car that is equipped with clutch actuators according to the application is more service friendly. This advantage applies especially, but not exclusively, for vehicles that are intended to be used in less developed areas.

Moreover, the parts an electromechanical clutch actuator according to the application can be made sturdy as compared to other electromechanical mechanisms that comprise levers, springs, rolls and the like. Therefore, the electromechanical clutch actuator according to the application can also be used for operation in harsh environments and for military vehicles.

The use of a stationary internal thread for both actuators of a double clutch makes it possible that the second cylindrical parts can be placed close to the output axis. Therefore, the lever arms of the clutch can be made large for achieving a large pressure force. Although the above description contains much specificity, these should not be construed as limiting the scope of the embodiments but merely providing illustration of the foreseeable embodiments. Especially the above stated advantages of the embodiments should not be construed as limiting the scope of the embodiments, but merely to explain possible achievements if the described embodiments are put into practise. Thus, the scope of the embodiments should be determined by the claims and their equivalents, rather than by the examples given.

Several modifications are possible. For example, the second and the first cylindrical parts of the second portion may be realized as one single part that has two outer threads or as a single part with one outer thread and teeth. The first cylindrical part may be realized as a cogwheel with teeth. The threads of the parts may also be left handed. The position of the motor and the rod may be swapped by approximately 180 degrees relative to the position shown in the drawings.

An arrangement of two electromechanical clutch actuators may also be used to actuate a double clutch of a type in which the clutches are actuated from different sides. In this arrangement, the second cylindrical parts are not nested within each other and the electromechanical clutch actuators may be constructed identically.

Instead of a cup shaped part, an internal threading may be used which is formed out of another part such as the clutch casing. The positions of the first and second cylindrical parts may also be swapped, which means that the internal thread and the second cylindrical part may be next to the clutch release bearing while the rod and the first cylindrical part are located further away from the clutch release bearing.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A clutch actuator assembly comprising:
an electric motor; and
a gear arrangement, the gear arrangement comprising:
a worm gear;
a threaded worm rod; and
a worm wheel with an actuator section, the worm wheel adapted for actuation by the threaded worm rod and the threaded worm rod adapted for actuation by the electric motor; the worm wheel further comprising:
an advance gear section with an advance thread; and
a stationary thread adapted to engage with the advance thread; and
a self-locking feature of the gear arrangement adapted to prevent the actuator section from moving when the electric motor is not actuated.

2. The clutch actuator assembly according to claim 1, wherein the self-locking feature comprises an angle of inclination of a second thread of the worm wheel.

3. The clutch actuator assembly according to claim 1, wherein the self-locking feature comprises an angle of inclination of the advance thread.

4. The clutch actuator assembly according to claim 1, wherein the self-locking feature comprises a plurality of angles of inclination of a second thread of the worm gear and the advance thread.

5. The clutch actuator assembly according to claim 1, wherein the self-locking feature comprises a shape of flanks of a thread of the threaded worm rod.

6. The clutch actuator assembly according to claim 1, wherein the self-locking feature comprises a shape of flanks of the advance thread of the threaded worm rod.

7. The clutch actuator assembly according to claim 5, wherein the flanks of the thread of the threaded worm rod are a saw-shaped thread.

8. The clutch actuator assembly according to claim 6, wherein the flanks of a thread of the advance thread are a saw-shaped thread.

9. The clutch actuator assembly according to claim 5, wherein the flanks of the thread of the threaded worm rod are a trapezoidal thread.

10. The clutch actuator assembly according to claim 6, wherein the flanks of the advance thread are a trapezoidal thread.

11. The clutch actuator assembly according to claim 1, wherein a thread of the worm wheel comprises a female thread on a first circumference of a first cylindrical part and the advance thread comprises a male thread on a second circumference of a second cylindrical part.

12. The clutch actuator assembly according to claim 1, wherein the stationary thread comprises an internal thread of a clutch casing.

13. The clutch actuator assembly according to claim 1, further comprising a guide adapted for moving the electric motor and the threaded worm rod along an axis of movement, wherein the electric motor and the threaded worm rod are adapted to move along the axis of movement and the guide is connected to the electric motor and adapted to engage with an engaging section connected to the worm wheel.

14. An arrangement of two clutch actuator assemblies for actuating a double clutch, comprising:
a first clutch actuator assembly adapted to actuate a first clutch of the double clutch, the first clutch actuator assembly comprising:
an electric motor; and
a gear arrangement, the gear arrangement comprising:
a worm gear;
a threaded worm rod; and
a worm wheel with an actuator section, the worm wheel adapted for actuation by the threaded worm rod and the threaded worm rod adapted for actuation by the electric motor; the worm wheel further comprising:
an advance gear section with an advance thread; and
a stationary thread adapted to engage with the advance thread; and
a self-locking feature of the gear arrangement adapted to prevent the actuator section from moving when the electric motor is not actuated; and
a second clutch actuator assembly adapted to actuate a second clutch of the double clutch,
wherein the advance thread of the first clutch actuator assembly is adapted to at least partially encloses a second advance thread of the second clutch actuator assembly.

15. The arrangement of two clutch actuator assemblies according to claim 14, the second clutch actuator assembly comprising:
an second electric motor; and
a second gear arrangement, the second gear arrangement comprising:
a second worm gear;
a second threaded worm rod; and
a second worm wheel with a second actuator section, the second worm wheel adapted for actuation by the second threaded worm rod and the second threaded worm rod adapted for actuation by the second electric motor; the second worm wheel further comprising:
a second advance gear section with the second advance thread; and
a second stationary thread adapted to engage with the second advance thread; and
a second self-locking feature of the second gear arrangement adapted to prevent the second actuator section from moving when the second electric motor is not actuated.

16. The arrangement of two clutch actuator assemblies according to claim 14, further comprising a bearing between the advance thread and the second advance thread.

17. The arrangement of two clutch actuator assemblies according to claim 14, wherein the self-locking feature comprises an angle of inclination of a second thread of the worm wheel.

18. The arrangement of two clutch actuator assemblies according to claim 14, wherein the self-locking feature comprises an angle of inclination of the advance thread.

19. The arrangement of two clutch actuator assemblies according to claim 14, wherein the self-locking feature comprises a plurality of angles of inclination of a second thread of the worm gear and the advance thread.

20. An arrangement of two clutch actuator assemblies for actuating a double clutch, comprising:
a first clutch actuator assembly adapted to actuate a first clutch of the double clutch, the first clutch actuator assembly comprising:
an electric motor; and
a gear arrangement, the gear arrangement comprising:
a worm gear;
a threaded worm rod; and
a worm wheel with an actuator section, the worm wheel adapted for actuation by the threaded worm rod and the threaded worm rod adapted for actuation by the electric motor; the worm wheel further comprising:
an advance gear section with an advance thread; and
a stationary thread adapted to engage with the advance thread; and
a self-locking feature of the gear arrangement adapted to prevent the actuator section from moving when the electric motor is not actuated; and
a second clutch actuator assembly adapted to actuate a second clutch of the double clutch, the second clutch actuator assembly comprising:
an second electric motor; and
a second gear arrangement, the second gear arrangement comprising:
a second worm gear;
a second threaded worm rod; and
a second worm wheel with a second actuator section, the second worm wheel adapted for actuation by the second threaded worm rod and the second threaded worm rod adapted for actuation by the second electric motor; the second worm wheel further comprising:
a second advance gear section with a second advance thread; and
a second stationary thread adapted to engage with the second advance thread; and
a second self-locking feature of the second gear arrangement adapted to prevent the second actuator section from moving when the second electric motor is not actuated.
wherein the advance thread of the first clutch actuator assembly is adapted to at least partially enclose the second advance thread of the second clutch actuator assembly.
